(19) United States
(12) Patent Application Publication
(10) Pub. No.: US 2007/0266224 A1
(43) Pub. Date: Nov. 15, 2007

(54) Method and Computer Program Product for Executing a Program on a Processor Having a Multithreading Architecture

(75) Inventor: Jurgen Gross, Rosenheim (DE)

Correspondence Address: EDELL, SHAPIRO & FINNAN, LLC, 1901 RESEARCH BOULEVARD, SUITE 400, ROCKVILLE, MD, 20850, US

(73) Assignee: FUJITSU SIEMENS COMPUTERS GMBH, Munich (DE)

(21) Appl. No.: 11/743,430

(22) Filed: May 2, 2007

(30) Foreign Application Priority Data
May 2, 2006 (DE) 102006020178.7

(51) Int. Cl. G06F 9/30

(52) U.S. Cl. 712/214

(57) ABSTRACT

The method for executing a program on a processor having a multithreading architecture includes identifying at least two processes of the program, the processes being executable independently of one another in a parallel manner and essentially using the same joint resources. The at least two identified processes are associated with different threads of the processor, and the program is then executed by executing the at least two identified processes in the associated threads in a parallel manner. As a result of the fact that those processes which essentially use the same joint resources are identified, the probability of capacity limits of those units of the processor which are not multiply provided in the processor being exceeded is reduced.

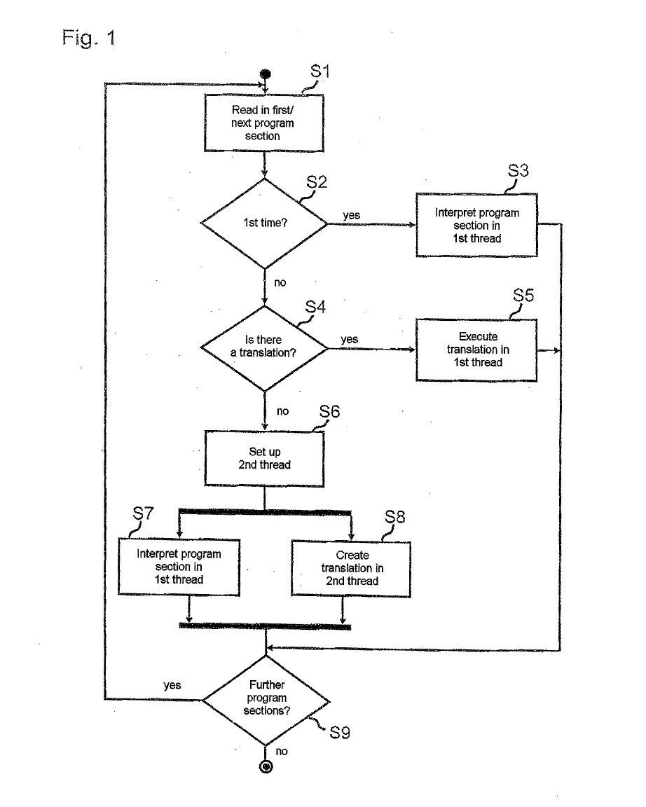

### CROSS REFERENCE TO RELATED APPLICATIONS

This application claims priority under 35 U.S.C. §119 to Application No. DE 102006020178.7 filed on May 2, 2006, entitled “Method and Computer Program Product for Executing a Program on a Processor Having a Multithreading Architecture,” the entire contents of which are hereby incorporated by reference.

### FIELD OF THE INVENTION

The invention relates to a method for executing a program on a processor having a multithreading architecture, in which a plurality of threads can be executed in a parallel manner with the assistance of hardware. The invention also relates to a computer program product which is suitable for carrying out the method.

### BACKGROUND

Processors usually have a central processing unit (arithmetic and logic unit, ALU) which sequentially processes instructions. The instructions and data processed using these instructions are loaded from a main memory and are made available to the central processing unit, if appropriate using so-called pipelines. However, the maximum capacity of the processing unit of a modern processor cannot practically be used in this manner without additional precautions since data and instructions to be processed often cannot be delivered from the main memory fast enough. Therefore, fast buffer stores, so-called cache memories, are usually provided for at least some of the data needed by the processing unit. These cache memories are often arranged on the same chip or else at least in the same housing as the processor, so that the processing unit can access them effectively. Such a cache memory can exhibit its advantages, in particular, when a data value is accessed more than once, since the cache buffer store must also be filled from the main memory during the first access operation. In addition to cache memories for data, i.e., for the contents of memory cells, it is also customary practice to provide cache memories in connection with address translation in processors having virtual memory addressing. Such cache memories are also referred to as translocation (or translation) lookaside buffers (TLB). If not specified in any more detail in the individual case, the term cache memory is to be understood below as meaning any form of fast buffer store of a processor irrespective of whether it is a data memory or an address memory.

Since the cache memories are usually completely or partially in the form of associative memories based on fast static memory cells, their capacities are usually relatively small in comparison with that of the main memory for reasons of cost. Consequently, entries in the cache memories must often be discarded during operation in order to provide space for new entries from the main memory. For these reasons, during operation of a processor, full use cannot be made of the processing unit of the latter under certain circumstances even when fast cache memories are used.

In the case of processors having a hardware-assisted multithreading architecture, parts of the processor are multiply designed or are at least duplicated, with the result that the processor appears to be a plurality of processors to the outside, i.e., with respect to the operating system and application programs. Computer systems containing a processor having a multithreading architecture are therefore sometimes also referred to as logic multiprocessor systems. Such a processor is able to execute a plurality of program strands or processes in a virtually parallel manner in the form of so-called threads. Some of the functional units of a processor, for example the instruction counter, registers and the interrupt controller, are usually multiply designed, whereas the parts which are expensive to implement, such as the processing unit and the cache memory, are provided only once. The threads are processed in rapid alternation by the jointly used central processing unit (in a virtually parallel manner). If one of the threads has to wait for data, another thread is processed by the central processing unit in the meantime, thus increasing the use of the central processing unit. The processor itself usually allocates processing time to the individual threads. In contrast, the process of setting up threads, i.e., the process of associating particular program strands or processes with a thread, can usually be influenced using the operating system.

However, if highly resource-intensive processes are executed in the virtually parallel threads, full use cannot be made of the central processing unit, even in the case of a processor having a multithreading architecture, when bottlenecks result in the case of further units which are not duplicated. For example, the capacity of the cache memories may not suffice to be able to simultaneously buffer-store the data of all virtually parallel threads in the case of memory-intensive processes which have access a large volume of data in the main memory. Each time the processor then changes from processing one thread to processing a next thread (referred to as a thread change for short in the text below), data which are associated with the first thread must then be discarded from the cache memory in order to provide space for the data of the next thread. The performance advantages which can be provided by the multithreading architecture are quashed under certain circumstances or are even reversed by virtue of this reloading process.

### SUMMARY

A method and computer program product are described which permit a processor having a multithreading architecture to execute a program in an effective manner and with the best possible use of the processor capability.

According to a first aspect of the invention, a method for executing a program on a processor having a multithreading architecture includes identifying at least two processes of the program, the processes being able to be executed independently of one another in a parallel manner and essentially using the same joint resources. The at least two identified processes are associated with different threads of the processor, and the program is then executed by executing the at least two identified processes in the associated threads in a parallel manner.

As a result of the fact that those processes which essentially use the same joint resources are identified, the probability of the resources which are used by the two threads being able to be simultaneously held in those units of the processor which are jointly used by them is increased. In the event of a thread change, i.e., when the processor changes from processing a first thread to processing a second thread, the jointly used units of the processor do not need to be changed over from the resources used by the first thread to the resources used by the second thread. The time needed to change over to the respective other resources is saved and the at least two processes of the program and thus the program itself can be processed effectively by the processor.

In one advantageous development of the method, the same jointly used resources are memory areas of a main memory of a computer. It is then particularly preferred, in the step of identifying the processes, to identify only those processes for which the jointly used memory areas have at least one point in time a similar size as a cache memory provided for the processor.

Processes which use a large memory area as a resource cannot be executed in a parallel manner with any desired other processes, which are likewise memory-intensive under certain circumstances, without resulting in the described problems in the event of a thread change. However, even in the case of processes which use a large memory area as a resource, the inventive method can make it possible to execute the processes in an advantageous and parallel manner under the stated requirements without the cache memories being disadvantageously reloaded in the event of a thread change.

In another advantageous refinement of the method, the step of identifying the at least two processes involves determining resources which are used by the processes. The inventive method can thus be used for any desired programs.

In another refinement of the method, the step of identifying the at least two processes involves determining tasks of the processes, the tasks implicitly revealing the resources used. If the method is used in programs in which, on account of the task of individual processes of the program, the use of its resources is already certain, this fact can advantageously be used to simplify the step of identifying processes which essentially use the same joint resources.

According to a second aspect, a computer program product having program code for executing a computer program on a computer, performs one of the aforementioned methods when executing the program code.

In one advantageous refinement, the computer program product is set up to dynamically emulate non-native program code on a processor, part of the non-native program code being interpreted in one of the at least two processes which are executed in a parallel manner in different threads, while the same part of the non-native program code is compiled in another one of the at least two processes which are executed in a parallel manner. In this refinement of the computer program product, use is made of the fact that the tasks of the program implicitly reveal the resources used. Otherwise, the resulting advantages of the second aspect correspond to those of the first aspect.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The invention will be explained in more detail below using an exemplary embodiment and with the aid of a figure. The figure shows a flowchart of a method for emulating non-native program code on a processor having a multithreading architecture, in which the inventive method is used.

### DETAILED DESCRIPTION

Only a first thread in which the method is sequentially performed as described below is provided. A second thread is used in the course of the method only at a suitable point in time in order to use the multithreading architecture of the processor as efficiently as possible for the purpose of rapidly and efficiently carrying out the emulation method.

In this case, the advantages of the inventive method best come to fruition, but not exclusively, when a thread of another program, in addition to the emulator, is not executed in a manner parallel to the first thread. In principle, the inventive method can also be applied to processes which are associated with different programs. However, for reasons of security and on account of the virtual addressing technology usually used in more modern processors, the address spaces, i.e., the memory areas used, of different programs are usually strictly separated, with the result that such processes do not have any overlapping memory resources.

After the process has been started, a first section of the program code to be emulated is read in a first step S1. The method described here is used to dynamically emulate the non-native program code. Various methods for emulating non-native program code are known from the prior art. On the one hand, the program code to be emulated can be read in and converted instruction by instruction. This is also known as interpreting. A second possibility is to read in the program code in sections, to translate each section in advance and then to execute it. Such an emulator is also known as a just-in-time compiler. A third possibility is dynamic emulation which can be considered to be a mixture of the two possibilities mentioned first. As in the case of a just-in-time compiler, the program code to be emulated is loaded in sections, but it is then interpreted and, only when it is determined that a program section is executed more frequently, is it translated for all further execution operations. The method presented here describes such dynamic emulation. Methods which define that section of the program code which is loaded in step 1 are known in this case. For example, jump instructions can be used as a separating criterion for defining the sections. In step S1, information for sequence control, which is collected during the process, is also loaded in addition to the section of the program code to be emulated. This information includes, for example, the number of times that section of the program code which has been read in has already been executed.

In a second step S2, this additional information is used to determine whether the program section which has been read in is to be executed for the first time. If so, the method branches to a step S3 in which this program section is interpreted instruction by instruction. Step S3 is carried out in the same first thread in which steps S1 and S2 were also carried out in the processor.

If the entire program section to be emulated has been interpreted, the method branches from step S3 to a step S9 which asks whether the program code to be emulated has been completely processed. If so, the method is concluded, otherwise the method branches back to step S1 in which the next program section to be emulated is then read in.

If step S2 determined that the program section to be emulated was not processed for the first time, the method branches from step S2 to a step S4.

In step S4, the additional information is used to determine whether there is already a translation for the program section which is to be emulated and has been read in. If so, the method branches to a step S5 in which the translation for the program section is executed. Like the interpretation in step S3, the translation is also directly executed in the first thread in step S5. If execution has ended, the method again branches to a step S9 from which the method is either concluded or branches back to step S1 in order to process a next program section.

If step S4 determined that there is not yet a translation for the program section to be emulated, the method branches to a step S6.

In step S6, the method sets up a new, second thread for execution virtually parallel to the first thread in which the method previously took place. As already mentioned above, a processor having a multithreading architecture appears to be a multiprocessor system to the operating system and thus to the application programs. An operating system which supports multiprocessor systems can thus be used to associate different processes with the individual logic processors and thus ultimately with the individual threads of a processor having a multithreading architecture.

In the method, two processes are accordingly then executed in a virtually parallel manner in the first and second threads in steps S7 and S8. In step S7, the program section to be emulated is interpreted in a similar manner to step S3 in the first thread. In a parallel manner, the program section to be emulated is compiled in the second thread in step S8. Both steps, i.e., interpreting and compiling, which are run in the two threads thus process the same program section to be emulated. The two threads therefore access essentially overlapping memory areas since both threads access both the program section to be emulated and the data in the main memory which are processed by them.

In the method described, two processes which can be executed independently of one another in a parallel manner and essentially use the same joint resources are consequently identified using the responsibility which these processes have in the method. On account of the large overlap of jointly used memory, there is a high probability of no contents of the cache memory (both data cache and translocation lookaside buffer) having to be exchanged in the event of a thread change even if each individual process requires a large amount of resources. The computing capacity of the processor can thus be used in an optimum and effective manner.

The resulting advantage for the dynamic emulation method is that the interpreting continues to be executed in step S7 and a translation is simultaneously available for any further repetition of the processed program section by virtue of the compiling in step S8. If the two steps were carried out in succession, i.e., first compiled and then translated, for example, the advantages resulting from the multithreading architecture of the processor could not be used to accelerate the emulation method. If, in contrast, advance translation is always carried out in a manner parallel to the processing of previously created translations in two threads, it would not be the case that the two threads executed in a parallel manner would favorably overlap in the memory areas used. The probability of contents of the cache memories having to be discarded and reloaded in the event of a thread change consequently increases.

After the translation in step S8 has been concluded, the second thread is initially not used any further. After the interpreting in step S7 has also been concluded, the method is consequently continued only in this first thread. Step S8 will usually be concluded before step S7 since pure compiling is less complex than interpreting. If that should not be the case as an exception, provision may be made to wait for the completion of the translation in step S8 at the end of step S7. In one alternative, after step S7 has been concluded, the method may be continued irrespective of whether or not step S8 has already been completed. In that case, before the translation created in step S8 may be used in the further course of the method, it is only necessary to wait for it to be completed. After step S7 has been concluded, the program branches to step S9, as after steps S3 and S5, in order to either be concluded or to branch to step S1 again for the purpose of processing a next program section.

In the emulation method described, the fact that the same program code section to be emulated is interpreted and compiled, respectively, could advantageously be used to easily determine processes which can be executed in a parallel manner and use joint resources. In alternative embodiments of the inventive method, such processes may also be directly identified by means of the resources used. For example, it is possible for two processes to respectively successively execute only a first section and, once this section has been executed, to determine the resources consumed, for example, the memory areas used, and to determine their overlap. A decision is then made as to whether these processes are executed in a virtually parallel manner in concurrent threads in the sense of the inventive method or whether it is more advantageous to run the processes in succession in one thread. Since processes usually do not have a constant resource consumption over their execution time but rather the latter changes dynamically during the running time, provision may be made for such checking of the overlap of jointly used resources to be repeatedly carried out at different points in time.

Having described exemplary embodiments of the invention, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A method for executing a program on a processor having a multithreading architecture, the method comprising:
(a) identifying at least two processes of the program that are executable independently of one another in a parallel manner and essentially use the same joint resources;
(b) associating the at least two identified processes with different threads of the processor; and
(c) executing the program by executing the at least two identified processes in the associated threads in a parallel manner.

2. The method as claimed in claim 1, wherein the same joint resources are jointly used memory areas of a main memory of a computer.

3. The method as claimed in claim 2, wherein (a) includes identifying only those processes for which the jointly used memory areas have at least one point in time a similar size as a cache memory provided for the processor.

4. The method as claimed in claim 1, wherein (a) involves determining resources which are used by the two processes.

5. The method as claimed in claim 1, wherein (a) involves determining tasks of the two processes, the tasks implicitly revealing the resources used.

6. A computer program product having program code for executing a computer program that, when executed on a computer, causes the computer to perform the following:
(a) identifying at least two processes of the computer program that are executable independently of one another in a parallel manner and essentially use the same joint resources;
(b) associating the at least two identified processes with different threads of a processor; and
(c) executing the computer program by executing the at least two identified processes in the associated threads in a parallel manner.

7. The computer program product as claimed in claim 6, wherein the same joint resources are jointly used memory areas of a main memory of a computer.

8. The computer program product as claimed in claim 7, wherein (a) includes identifying only those processes for which the jointly used memory areas have at least one point in time a similar size as a cache memory provided for the processor.

9. The computer program product as claimed in claim 6, wherein (a) involves determining resources which are used by the two processes.

10. The computer program product as claimed in claim 6, wherein (a) involves determining tasks of the two processes, the tasks implicitly revealing the resources used.

11. The computer program product as claimed in claim 6, wherein the computer program further causes the computer to dynamically emulate non-native program code on the processor, part of the non-native program code being interpreted in one of the at least two processes which are executed in a parallel manner in different threads, while the same part of the non-native program code is compiled in another one of the at least two processes which are executed in a parallel manner.
